(19) United States
(12) Patent Application Publication
(10) Pub. No.: US 2012/0193377 A1
(43) Pub. Date: Aug. 2, 2012

(54) NASAL SPRAY PUMP

(75) Inventor: Paxton Wong, Maroubra (AU)

(73) Assignee: MK INTERNATIONAL PTY LTD, Maroubra (AU)

(21) Appl. No.: 13/394,508

(22) PCT Filed: Sep. 7, 2010
(86) PCT No.: PCT/AU2010/001157

§ 371 Date: Apr. 19, 2012

(30) Foreign Application Priority Data
Sep. 7, 2009 (AU) 2009904247
Sep. 30, 2009 (AU) 2009904733

(51) Int. Cl. B65D 88/54; B23P 11/00

(52) U.S. Cl. 222/320; 29/428; 222/162

(57) ABSTRACT

A nasal spray pump comprises a reservoir extending between a closed end and an open end. A cap is disposed over the open end. A stem extends between an outlet end and a lower end, the stem having a conduit. A piston is disposed the stem and is configured for movement between a first position wherein the piston seals or substantially seals a conduit inlet and a second position wherein the piston is moved away from the first piston position to open the conduit inlet to the contents of the reservoir. The stem is configured for movement from a first stem position wherein the piston is disposed in or over the reservoir in the first piston position and a second stem position wherein the stem is moved toward the closed end of the reservoir such that the piston is moved into the second piston position.

### FIELD OF THE INVENTION

The present invention relates to intranasal substance delivery systems and, in particular, to a nasal spray pump system.

The invention has been developed primarily to allow nasal delivery of a single dose of therapeutic substance and will be described hereinafter with reference to this application. However, it will be appreciated that the invention is not limited to this particular field of use and is capable of the nasal delivery of non-therapeutic substances, as well as delivery to the skin, hair, eyes or a body cavity other than a nostril.

### BACKGROUND OF THE INVENTION

Of recent times, it has become apparent that many pharmaceutical substances such as insulin, hormones, asthma treatments, lipophyllic drugs, opiates, erectile dysfunction medication, migraine medication or other therapeutic substances can be efficaciously delivered intranasally. This offers significant advantage, for example, where diabetics can intranasally receive insulin rather than subcutaneously by means of a needle.

This particular advantage is also provided for the use of hormone treatments amongst many other therapeutic substances. It is desired that a regular user can simply have provided an intranasal delivery device so that at any convenient time a dose of therapeutic substance can be taken. It will be appreciated that significantly less privacy is required to intranasally deliver a therapeutic substance as opposed to that required to inject the same substance via a syringe, and that hygiene requirements are reduced.

It is undesirable to expose a therapeutic substance user to the possibility of intranasally consuming more of the substance than is desired. BD Medical Pharmaceutical Systems of France offer for sale under the trademark ACCUSPRAY a nasal spray system which allows the delivery of therapeutic materials. The BD Medical Pharmaceutical Systems nasal spray pump is a syringe type device configured to receive a cartridge containing a single dose of a therapeutic substance. The intranasal spray device receives the cartridge longitudinally and the cartridge is configured to rupture adjacent an opening. The cartridge includes a plunger which is actuated by a secondary plunger on the nasal spray device so as to dispense the therapeutic goods by a plunging action and forcing the contents from the cartridge.

That is, a plunger is longitudinally moved to engage with a cartridge plunger which is linearly moved away from the direction the nasal spray is to be dispensed and is similar to a syringe in function, especially dental syringes configured to receive cartridges of oral anaesthetic. In a dental syringe, the contents of the cartridge are plunged from one end longitudinally and out the other. The BD Medical Pharmaceutical Systems device plunges from one end longitudinally and the contents are forced out the same end through an aperture in the plunger.

A significant disadvantage with this development resides in the single use of the cartridges whereby once the plunger has been plunged it cannot be removed to be re-plunged to allow any unused or undispensed therapeutic goods to be dispensed.

In another attempt at providing a single dose nasal spray system, U.S. Pat. No. 6,948,492 (Wermeling et al) discloses the use of an apparatus for the self-administration of liquid pharmaceutical compositions intranasally. In this patent, a body is configured to contain a plurality of radially extending and circumferentially spaced apart vials each containing a single dose of a therapeutic substance. Each of the vials is sealed in a housing which is electronically controlled to allow rotation of a body cover at predetermined intervals to expose the opening of one of the vials. Each vial includes a plunger having a fluid channel disposed substantially longitudinally through the centre thereof. The channel is configured to receive a needle tip extending from a lower end of a nasal applicator head.

In use, once a vial has been exposed at a predetermined time, the nasal spray applicator head is engaged with the housing so that the needle is received within the fluid channel of the plunger. Movement of the applicator head downwardly toward the bottom of the vial causes the contents of the vial to be plunged through the needle running through the fluid channel and out an aligned channel in the nasal applicator which is configured to be disposed in or adjacent a user's nose.

The lower end of the plunger in each vial includes a recess to receive the nasal spray applicator needle so that once the plunger is fully moved to the bottom of the vial, the needle does not engage with the bottom of the vial so as not to damage the needle or the bottom of the vial.

Unfortunately, the electronic control of this device means that a user needs to wait a predetermined time before being able to access another vial containing therapeutic materials. In the case of a diabetic, for example, this may be particularly undesirable as usage of insulin is not necessarily a function of elapsed time between a previous dose. Furthermore, the use of the needle on the lower end of the nasal applicator is disadvantageous so far as the needle tip is exposed to contamination when removing it from one vial and engaging it with another vial. Yet further, the plunger needs to be made to relatively high tolerances to avoid the needle extending deeper than the plunger when fully plunged.

It will be appreciated that the recess provided to receive the needle tip at the bottom end of the plunger disadvantageously retains some contents of the vial due to its intrinsic nature. Unfortunately, it is not possible to re-actuate the nasal sprayer of either this U.S. patent or the BD Medical Pharmaceutical Systems device by replunging the vial so that any contents that remain cannot be dispensed.

Both the BD Medical Pharmaceutical Systems nasal device and the Wermeling et al device require specialised manufacturing techniques and components to effect these single dose nasal sprayers. Furthermore, it will be appreciated that different sized doses of therapeutic substances cannot be accommodated in either of the prior art nasal sprayers. For example, the Wermeling et al disclosure is limited by the configuration and size available to receive a vial within the housing and the BD Medical Pharmaceutical Systems device can also only take a particular sized dose. It is therefore the case that in order to dispense a plurality of different sized doses, different sized intranasal dispensing apparatus would be required accordingly. This is disadvantageous insofar as it unnecessarily adds to costs in providing different devices for different sized doses.

### GENESIS OF THE INVENTION

The genesis of the present invention is a desire to provide a single dose nasal spray device which will overcome or substantially ameliorate one or more of the disadvantages of the prior art, or to provide a useful alternative.

### SUMMARY OF THE INVENTION

In accordance with a first aspect of the present invention there is provided a single dose nasal spray pump comprising:
a reservoir configured for holding a single dose of material to be dispensed, the reservoir extending between a closed end and an open end;
a cap configured to be disposed over the open end of the reservoir, the cap including an aperture;
a stem extending between an outlet end and a lower end, the stem having a conduit extending from the outlet end of the stem to a conduit inlet at or adjacent the lower end of the stem; and
a conduit inlet valve disposed about part or all of the stem and configured for movement between a first position wherein the conduit inlet valve seals or substantially seals the conduit inlet and a second position wherein the conduit inlet valve is moved away from the first valve position to open the conduit inlet;
wherein the stem is configured for movement from a first stem position wherein the conduit inlet valve is disposed in or over the reservoir in the first valve position and a second stem position wherein the stem is moved toward the closed end of the reservoir such that the conduit inlet valve is moved into the second valve position.

In accordance with a second aspect of the invention there is provided a nasal spray pump configured to receive a reservoir extending between an open end and a closed end and configured to contain a predetermined dose of material to be delivered intra-nasally wherein the reservoir is configured to receive a sealing cap over the open end of the reservoir such that the cap includes an aperture, the nasal spray pump comprising:
a stem extending between an outlet end and a lower end, the stem having a conduit extending from the outlet end of the stem to a conduit inlet at or adjacent the lower end of the stem; and
a conduit inlet valve disposed about part or all of the stem and configured for movement between a first position wherein the conduit inlet valve seals or substantially seals the conduit inlet and a second position wherein the conduit inlet valve is moved from the first valve position to open the conduit inlet;
wherein the stem is configured for movement from a first stem position wherein the conduit inlet valve is disposed in or over the reservoir in the first valve position and a second stem position wherein the stem is moved toward the closed end of the reservoir such that the conduit inlet valve is moved into the second valve position.

In accordance with a third aspect of the invention there is provided a method of providing a nasal spray pump, the method comprising the steps of:
providing a reservoir capable of containing a single dose of material to be dispensed such that the reservoir extends between a closed end and an open end;
providing a cap over the open end of the reservoir wherein the cap includes an aperture;
providing a stem through the cap aperture wherein the stem extends between an outlet end and a lower end, the stem having a conduit extending from the outlet end of the stem to a conduit inlet at or adjacent the lower end of the stem; and
disposing a conduit inlet valve about part or all of the stem wherein the conduit inlet valve is movable between a first position wherein the conduit inlet valve seals or substantially seals the conduit inlet and a second position wherein the conduit inlet valve is moved away from the first valve position to open the conduit inlet; and
configuring the stem for movement from a first stem position wherein the conduit inlet valve is disposed in or over the reservoir in the first valve position and a second stem position wherein the stem is moved toward the closed end of the reservoir such that the conduit inlet valve is moved into the second valve position.

In accordance with another aspect of the invention there is provided a nasal spray pump valve for a nasal spray pump having a reservoir extending between an open end and a closed end and configured to contain a predetermined dose of material to be delivered intra-nasally, the reservoir being configured to receive a sealing cap over the open end of the reservoir such that the cap includes an aperture, the nasal spray pump valve comprising:
a stem extending between an outlet end and a lower end, the stem having a conduit extending from the outlet end of the stem to a conduit inlet, at or adjacent the lower end of the stem; and
a conduit inlet valve disposed about part or all of the stem and movable between a first position wherein the conduit inlet valve seals or substantially seals the conduit inlet and a second position wherein the conduit inlet valve is moved from the first conduit inlet valve position to open the conduit inlet;
wherein the stem is movable from a first stem position wherein the conduit inlet valve is disposed in or over the reservoir in the first conduit inlet valve position and a second stem position wherein the stem is moved toward the closed end of the reservoir such that the conduit inlet valve is moved into the second conduit inlet valve position.

It can be seen that there is advantageously provided a single dose nasal spray pump and a valve therefor that do not employ piecing needle tips or the like. Furthermore, it will be appreciated that the nasal spray pump advantageously allows the stem to be moved toward the second stem position before providing egress to the material in the reservoir via the stem conduit. It will also be appreciated that if desired any preferred sized reservoir containing a predetermined sized dose of material can be used without requiring a new nasal spray pump pumping mechanism.

### BRIEF DESCRIPTION OF THE DRAWINGS

Preferred embodiments of the invention will now be described, by way of example only, with reference to the accompanying drawings in which:

FIG. 1 is a exploded front view of a nasal spray pump according to a first preferred embodiment;

FIG. 2 is a cutaway front view of the nasal spray pump of FIG. 1;

FIG. 3 is a cutaway front view of the nasal spray pump of FIG. 1 with a nasal spray pump head;

FIG. 4 is a front view of the nasal spray pump of FIG. 3;

FIG. 5 is an elevated perspective view and partial cutaway of a reservoir and collar according to the preferred embodiment of the nasal spray pump of FIG. 1;

FIG. 6 is a front view of a nasal spray pump according to a second preferred embodiment;

FIG. 7 is a partial cutaway front view of the nasal spray pump of FIG. 6;

FIG. 8 is a front view of a nasal spray pump according to a third preferred embodiment;

FIG. 9 is a bottom perspective view of the nasal spray pump of FIG. 8;

FIG. 10 is an elevated perspective view of the nasal spray pump of FIG. 8;

FIG. 11 is a side view of the nasal spray pump of FIG. 8;

FIG. 12 is a cut-away front view along the line A-A of FIG. 11;

FIG. 13 is an exploded elevated perspective view of the nasal spray pump of FIG. 8;

FIG. 14 is a rear view of the nasal spray pump of FIG. 8;

FIG. 15 is a plan view of the nasal spray pump of FIG. 8; and

FIG. 16 is an inverted plan view of the nasal spray pump of FIG. 8.

### DETAILED DESCRIPTION

It will be appreciated that throughout the description of the preferred embodiments like reference numerals have been used to denote like components unless expressly noted otherwise.

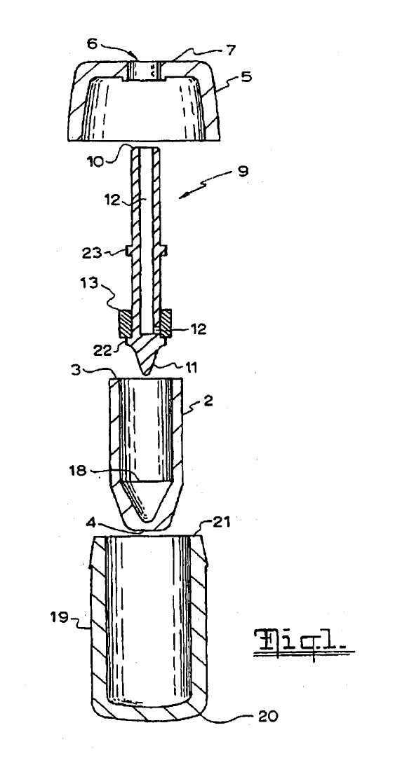

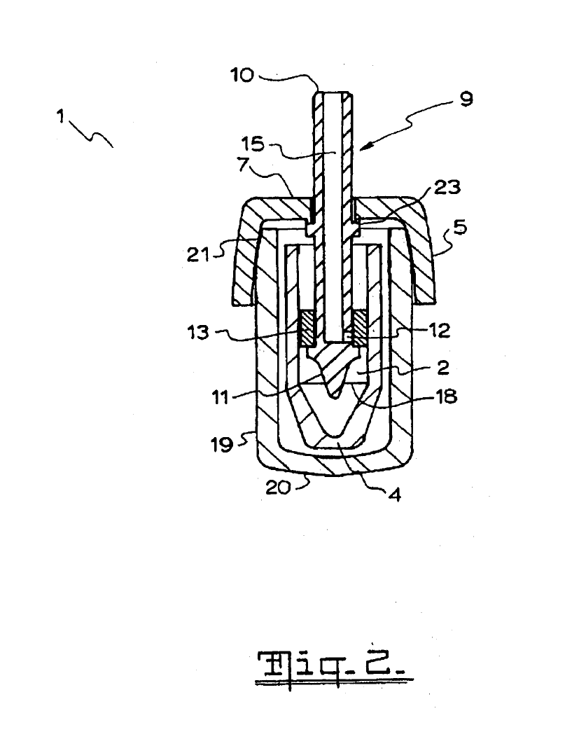

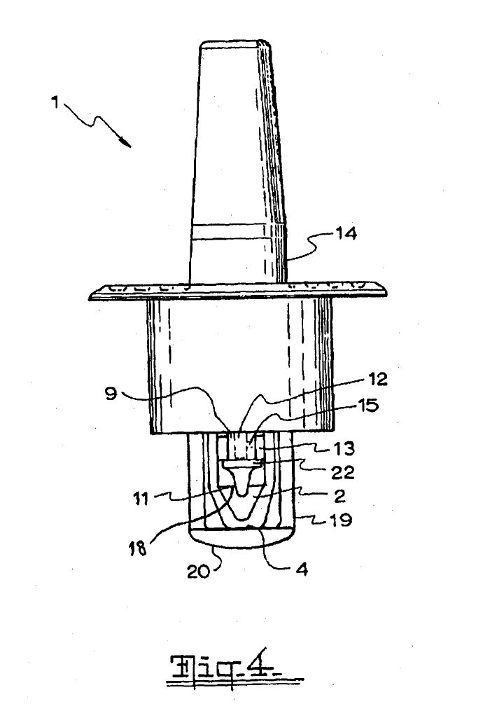

Referring to FIGS. 1 to 5, there is shown a nasal spray pump 1 according to the first preferred embodiment. The nasal spray pump 1 includes a reservoir 2 configured for holding a single dose of material (not illustrated) to be dispensed. The reservoir 2 extends between a closed end 3 and an open end 4. A cap 5 is configured to be disposed over the open end 4 of the reservoir 2. The cap 5 includes an aperture 6 centrally disposed on an upper surface 7 of the cap 5.

A stem 9 longitudinally extends between an outlet end 10 and a lower end 11. The stem 9 includes a conduit 12 extending from outlet end 10 of the stem 9 to, or adjacent to, the lower end 11 of the stem. A conduit inlet valve in the form of a piston 13 is disposed about the stem 9. The piston 13 is configured to move between a first piston position (as shown in the drawings) wherein the piston 13 seals or substantially seals the conduit 12 inlet at the lower end 11 of the stem 9, and a second piston position (not illustrated) wherein the piston is moved along the stem 9 away from the first piston position to open the conduit 12 inlet at the lower end to material in the reservoir 2. It will be appreciated that the conduit inlet valve need not to be cylindrical nor fully encircle the stem 9 provided that it blocks the conduit 12 when the stem is in the first stem position and moves clear of the conduit inlet when the stem is moved to the second stem position.

The stem 9 is configured to be retained in the aperture 6 of the cap 5 when the cap 5 is disposed over the open end 4 of the reservoir 2. The stem 9 is also configured for sliding movement through the aperture 6 of the cap 5. between a first stem position (as shown in the drawings) wherein the piston is disposed in the reservoir 2 in the first piston position and a second stem position (not illustrated) wherein the stem 9 is moved toward the closed end 3 of the reservoir 2 where the piston 13 is moved from the first piston position to the second piston position (not illustrated). It will be appreciated that the piston 13 can alternatively sit on top of the reservoir open end 4 in other preferred embodiments if desired. The piston 13 needs to seal or substantially seal with both the reservoir 2 and the stem 9 in the first preferred embodiment.

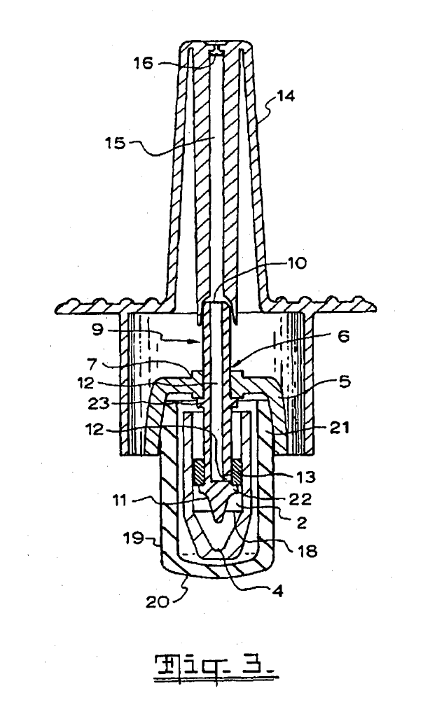

As best shown in FIGS. 3 and 4, the nasal spray pump 1 includes a nasal spray pump head 14 configured to be received by the outlet end 10 of the stem 9. The nasal spray pump head 14 includes a path 15 through which material travelling through the outlet end 10 of the stem 9 can pass and exit at a nasal spray pump head aperture 16 configured to be disposed in or adjacent to a nasal cavity of a user to receive material dispensed therefrom.

A piston engagement means 18 is disposed within the reservoir 2 a predetermined . height above the closed end 3. In the preferred embodiment, the piston engagement means 18 is formed by a taper in the lower end of the reservoir 2, however, it may be an inwardly projecting circumferentially disposed seat or one or more circumferentially disposed projections extending radially inwardly a predetermined distance to stop or catch the piston 13. The piston engagement means 18 extends the predetermined distance such that movement of the stem towards the second stem position causes the piston 13 to engage with the piston engagement means 18 to retain or retard movement of the piston 13 toward the closed end 3 of the reservoir 2. That is as the stem 9 is moved into the stem second position, the piston 13 engages with the piston engagement means 18 and the stem 9 is continued toward the stem second position with the piston 13 retained thereby exposing the conduit 12 inlet. The conduit 12 is then in communication with the material in the reservoir 2 and it is then able to flow therethrough.

As the stem is moved into the stem second position and the piston 13 engages the piston engagement means 18, movement of the stem 9 into the second stem position causes the material disposed in the reservoir 2 to be forced out under pressure through the conduit 12 to exit the outlet end 10 of the stem 9. The material then travels through path 15 in the nasal spray pump head 14 to exit at the nasal spray pump head aperture 16 for delivery to a nasal cavity (nostril) of a user.

The nasal spray pump 1 of the preferred embodiment further includes a canister 19 extending between a closed end 20 and an open end 21. The cap 5 is configured to be disposed over and seal the open end 21 of the canister 19. The cap 5 can be crimped about, or clipped or screwed on to the reservoir 2 and/or the canister 19 as desired. It will be appreciated that lithe reservoir 2 is disposed in the canister 19 that the open end 4 of the reservoir 2 or the canister 19 does not need to form a seal with the cap 5 as this function is performed by the upper end 20 of the canister 19 or the upper end 3 of the reservoir 2. In other embodiments, not illustrated, the, cap 5 releasably engages with the canister 19 and/or the reservoir 2 so as to allow for the reservoir 2 to be replaced with a new reservoir having material therein.

The piston 13 is also engaged about the stem 9 in an interference fit so as to provide resistance to movement of the piston 13 from the first piston position where the conduit 12 is sealed or substantially sealed by the piston 13.

A lower shoulder 22 is disposed about the stem 9 to provide a seat or stop means to prevent the piston moving down the stem 9 toward the lower end 11. An upper shoulder 23 is disposed about the stem 9 and spaced apart from the lower shoulder 22 toward the outlet end 10 of the stem 9 to prevent movement of the stem 9 away from the closed end 3 of the reservoir 2. This essentially limits the length of travel of the stem 9 within the cap 5 between the first stem position and the second stem position. Whilst shoulders 22 & 23 are disposed entirely about the stem 9 they can, as desired, be replaced by circumferentially disposed projections or other means to limit the movement of the stem 9.

The lower end 11 of the stem 9 is shaped to conform to a corresponding shape of the closed end 3 of the reservoir 2. This advantageously provides for the lower end 11 to substantially fill the lower end of the reservoir 2 when the stem 9 is moved to the second stem position. Although the lower end 11 of the stem 9 is shown in the form of a protrusion, this can be substantially flat or any other preferred shape.

It will be appreciated that the piston 13 is not resiliently biased away from the lower end 11 of the stem 9 and that the lower end 11 once the stem 9. has moved into the second stem position is retained in that position. A return spring or other resilient biasing means can be provided to return the stem 9 from the second stem position to the first stem position which is most advantageous in cases where the reservoir 2 is to be interchanged after its contents are dispensed.

However, it will be appreciated that in the case of a single use only arrangement, the nasal spray pump 1 can be modified to physically retain the stem 9 in the second stem position. Although not illustrated in the drawings, it will be appreciated that when the stem 9 is moved into the second stem position the stem 9 can engage with the cap 5 to retain or lock the stem in that position and prevent movement of the stem 9 back towards the first stem position. This can be achieved in any desired way such as by use of a sloped projection extending from the cap 5 or the stem 9 for engagement in a corresponding recess disposed in the stem 9 or the cap 5 respectively, for example.

In other preferred embodiments (not illustrated) it will be understood that multiple exits, if desired, for the conduit 12 may be disposed in the stem 9, preferentially circumferentially thereabout, at the lower end of the stem to be disposed under the piston 13 when is in the first piston position.

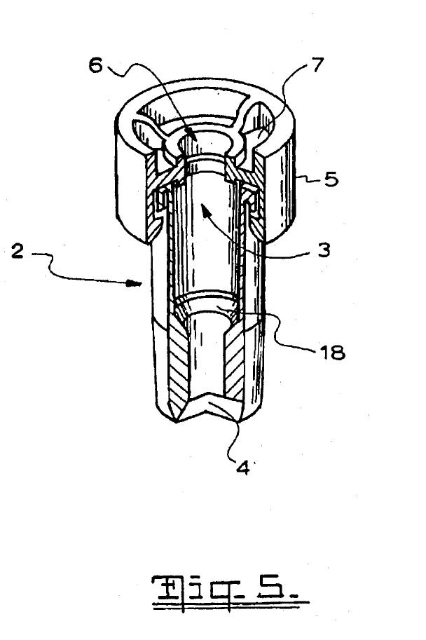

Referring now to FIGS. 6 and 7, there is shown a nasal spray pump 1 according to a second preferred embodiment. In this preferred embodiment, it will be appreciated that like reference numerals have been used to denote like components. FIG. 6 is a front view of the nasal spray pump 1 of the second preferred embodiment, and FIG. 7 is a partial cutaway front view of a nasal spray pump 1 of FIG. 6.

In this preferred embodiment, the canister 19 is not used and the reservoir 2 sealingly engages with the collar 5. The piston 13 is resiliently biased into the first piston position, as shown in FIGS. 6 and 7. A slight interference fit between the piston 13 and stem 9 is also provided to provide bias against movement of the piston 13 into the second piston position. A compression spring 17 is disposed about the stem 9 to bias the piston 13 into the first piston position with a predetermined force. The spring 17 is disposed about the stem 9 intermediate the shoulder 23 and the piston 13. The piston 13 is engaged at a lower end at a lower shoulder 22.

As best seen in FIG. 7 a second upper shoulder 23B is spaced apart from the upper shoulder 23 toward the outlet end 10 of the stem 9 is also provided. The second upper shoulder 23B is retained within the collar 5.

It can be seen that in the second embodiment, movement of the stem 9 toward the closed end 3 of the reservoir 2 into the second stem position causes the piston 13 to engage with the piston engagement means 18 to retain or retard movement of the piston 13 relative to the stem 9 whilst allowing downward movement of the stem 9. The spring 17 provides a bias against movement of the piston 13 from the first piston position to the second piston position.

As with the first preferred embodiment described in FIGS. 1 to 5, movement of the stem 9 to the second stem position and movement of the piston 13 into the second piston position unseals or moves clear of the exit of the conduit 12 about which the piston 13 is disposed in the first piston position to allow material in the reservoir 2 to be dispensed through the conduit 12 and through the outlet end 10 of the stem 9 for dispensing intranasally. It will be appreciated that piston engagement means 18 can be removed and the piston 13 moved against the bias of spring 17 under the influence of the pressure provided by movement of the stem 9 and/or piston 13 toward the closed end 3 of the reservoir 2.

Nasal spray pump head 14 is shown in FIGS. 6 and 7 to facilitate use of the nasal spray pump 1 and delivery of the contents to the users nasal cavity.

The foregoing describes only two preferred embodiments of the present invention and modifications, obvious to those skilled in the art, can be made thereto without departing from the scope of the present invention. For example, the nasal spray pump 1 can be used to deliver a single dose of material to the eyes and skin of a person, as well as into a body cavity other that a nostril. Furthermore, it will be appreciated that the stem 9 need not be centrally located in the cap and that the piston 13 needs only seal or substantially seal the stem conduit 12 until pressure or by a mechanical action such as the piston engagement means 18 shown in FIG. 1 cause the piston 13 to move relative to the stem 9 and clear of the conduit 12 and allow material in the reservoir 2 to be ejected through the conduit 12 and out the stem outlet end 10. The piston therefore need not be disposed entirely about the stem 9 nor seal about the inner surface of the reservoir 2.

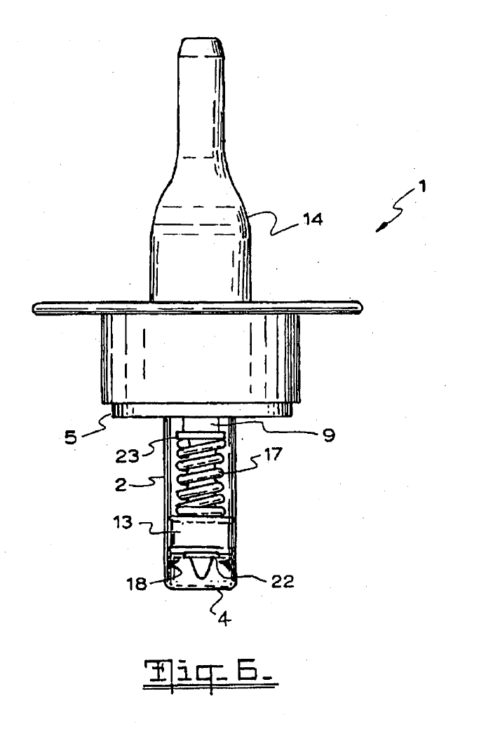

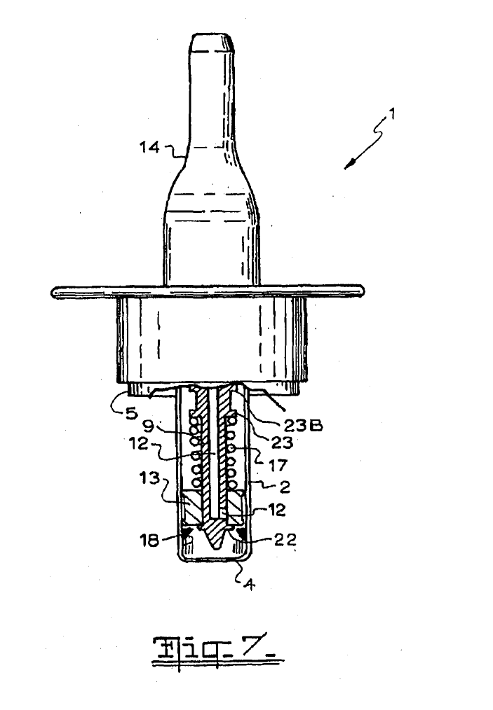

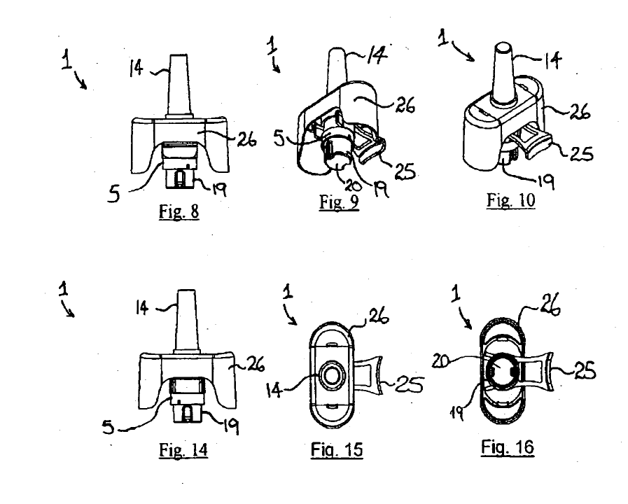

Reference is now made generally to FIGS. 8 to 16 showing various views of a nasal spray pump 1 according to a third preferred embodiment. In this embodiment, the reservoir 2 and the canister 19 are retained against the cap 5. In addition to the nasal spray pump head 14, a head cover 26 is disposed thereover to more easily manually manipulate or actuate and depress the head 14 and stem 9. The head 14 is received though an aperture 27 of the head cover 26.

The cover 26 engages with the head 14 via locking tabs 27 extending from an underside of the cover 26. Additionally, a removable locking pin 25 is provided to extend under projections 28 on head 14 so that the locking pin 25 is disposed intermediate projections 28 and the upper surface 7 of the cap 5. This restrains movement of the head 14 towards the reservoir 2 until desired by a user to avoid accidental movement of the bead 14 and discharge of material in the reservoir 2.

The cap 5 includes a cylindrical projection 32 extending upwardly a predetermined distance. A secondary collar 33 extending down from the head 14 engages with the projection 32 to more stabily accommodate the actuator 14. That is, rather than the head 14 engaging only with the stem 9 as in the preferred embodiment of FIGS. 1 to 5, in this third preferred embodiment the head 14 engages about both the stem 9 and also cap projection 32. This laterally stabilises the head 14 and the stem 9.

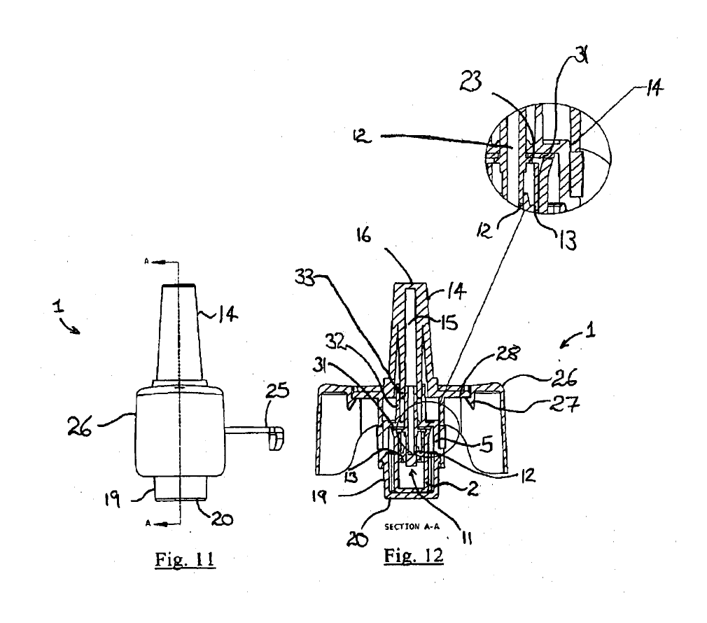

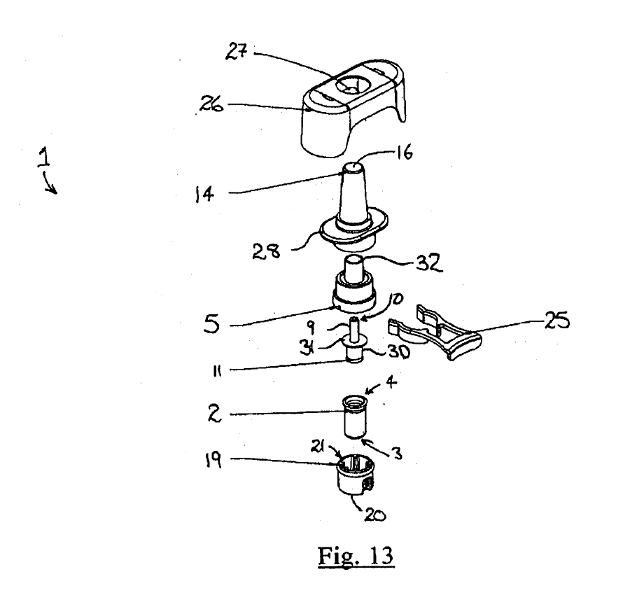

In this embodiment, the piston engagement means 18 is not provided. As best shown in the exploded view of FIG. 13, the piston 13 (not clearly shown) is formed by or is disposed within a housing 30. The lower end 11 of the stem 9 is disc-like and above this is the stem conduit inlet 12 disposed under the housing 30 and piston 13 with the piston 13 in the first piston position.

A collar or flange 31 is disposed at a top end of the housing 30. The collar 31 is disposed intermediate the cap 5 and the reservoir 2 open end 4 to provide a seal therebetween. As the lower end 11 of the stern 9 is moved toward the closed end 3 of the reservoir 2, the lower end 11 of the stem 9 is moved downwardly relative to the housing 30 to uncover the conduit inlet 12 such that the piston 13 is moved into the second piston position. Pressure in the reservoir 2 then causes the material in the reservoir 2 to be forced out of the now uncovered conduit 12. the lower end 11 of the stern 9 preferably moves to the bottom of reservoir 2 when the stem 9 is moved into the second stem position (not shown in FIGS. 8 to 16) to ensure maximum displacement of the material in the reservoir 2. Although not seen in FIG. 12, the lower end of the 11 of the stem 9 includes a silicone ring to provide the maximum displacement when the stem 9 is moved into the second stem position.

In use, the locking pin 25 is removed and the nasal spray pump actuated per the first two embodiments by moving the 9 stem toward the closed end 3 of the reservoir 2. This moves the stem to the second stem position and the piston 13 to the second piston position and material flows through the conduit 12 and exits an aperture 16 of the head 14.

It is noted that the collar 31 on piston housing 30 aides engagement of the reservoir 2 open end 4 with the cap 5. Also, the open end 4 of the reservoir 2 is flared outwardly to improve engagement of reservoir 2 and cap 5 via the collar 31.

It will be appreciated that in an alternative embodiment (not illustrated), the collar 31 need not be used A piston engagement means 18 may be disposed in the reservoir 2 to restrain the housing 30 upon movement of the stem 9 to allow the piston 13 to be moved into the second position.

The term “comprising” (and its grammatical variations) as used herein is used in the inclusive sense of “including” or “having” and not in the exclusive sense of “consisting only of”.

1. A single dose nasal spray pump comprising:
a reservoir configured for holding a single dose of material to be dispensed, the reservoir extending between a closed end and an open end;
a cap configured to be disposed over the open end of the reservoir, the cap including an aperture;
a stem extending between an outlet end and a lower end, the stem having a conduit extending from the outlet end of the stem to a conduit inlet at or adjacent the lower end of the stem; and
a conduit inlet valve disposed about part or all of the stem and configured for movement between a first position wherein the conduit inlet valve seals or substantially seals the conduit inlet and a second position wherein the conduit inlet valve is moved away from the first valve position to open the conduit inlet;
wherein the stem is configured for movement from a first stem position wherein the conduit inlet valve is disposed in or over the reservoir in the first valve position and a second stem position wherein the stem is moved toward the closed end of the reservoir such that the conduit inlet valve is moved into the second valve position.

2. A nasal spray pump according to claim 1 wherein the conduit inlet valve is a piston.

3. A nasal spray pump according to claim 1 wherein the reservoir includes a conduit inlet valve engagement means disposed a predetermined distance from the reservoir closed end.

4. A nasal spray pump according to claim 3 wherein the conduit inlet valve engagement means includes a radially inwardly projecting seat portion extending a predetermined distance for engagement with the conduit inlet valve when the stem is moved from the first stem position to the second stem position.

5. A nasal spray pump according to claim 1 wherein the stem is configured to be retained in the cap aperture and the stem includes a pair of shoulders spaced apart therealong and configured to be disposed within the inside of the reservoir and wherein a lower shoulder is configured to limit movement of the conduit inlet valve toward the lower end of the stem.

6. A nasal spray pump according to claim 2 wherein the piston engages about the stem in a interference fit.

7. A nasal spray pump according to claim 2 wherein the piston is resiliently biased into the first conduit inlet valve position.

8. A nasal spray pump according to claim 2 including a spring disposed about the stem intermediate the piston and an upper shoulder.

9. A nasal spray pump according to claim 1 wherein the reservoir lower end is shaped such that the lower end of the stem substantially conforms thereto when the stem is moved into the second stem position.

10. A nasal spray pump according to claim 1 wherein the stem is configured to be retained in the stem second position when moved from the first stem position.

11. A nasal spray pump according to claim 1 wherein the cap or the cap aperture engage with the stem when the stem is moved to the second stem position to retain the stem in that position.

12. A nasal spray pump according to claim 1 wherein the outlet end of the stem is configured to receive a nasal spray pump dispensing head.

13. A nasal spray pump according to claim 1 wherein the cap is fixedly mounted to the reservoir or is removably mounted to the reservoir; or wherein the cap is configured to be clipped on to, crimped about, or screwed on to the open end of the reservoir.

14. A nasal spray pump according to claim 1 wherein the reservoir is releasably mountable to the cap for replacement of the reservoir subsequent to dispensing material stored in the reservoir.

15. A nasal spray pump according to claim 3 wherein the dose of material to be dispensed is contained in the reservoir at a level at or below the conduit inlet valve engagement means.

16. A nasal spray pump according to claim 1 wherein the lower end of the stern is substantially conical.

17. A nasal spray pump according to claim 1 wherein the open end of the reservoir is sealed or substantially sealed by the cap.

18. A nasal spray pump according to claim 1 including a canister extending between a closed end and an open end, the canister configured to receive the reservoir and to form a seal with the cap.

19. A nasal spray pump according to claim 11 wherein the upper end of the stem is tapered to provide a substantially sealed interference fit with the nasal spray pump head.

20. A nasal spray pump configured to receive a reservoir extending between an open end and a closed end and configured to contain a predetermined dose of material to be delivered intra-nasally wherein the reservoir is configured to receive a sealing cap over the open end of the reservoir such that the cap includes an aperture, the nasal spray pump comprising:
a stem extending between an outlet end and a lower end, the stem having a conduit extending from the outlet end of the stem to a conduit inlet at or adjacent the lower end of the stem; and
a conduit inlet valve disposed about part or all of the stem and configured for movement between a first position wherein the conduit inlet valve seals or substantially seals the conduit inlet and a second position wherein the conduit inlet valve is moved from the first valve position to open the conduit inlet;
wherein the stem is configured for movement from a first stem position wherein the conduit inlet valve is disposed in or over the reservoir in the first valve position and a second stem position wherein the stem is moved toward the closed end of the reservoir such that the conduit inlet valve is moved into the . second valve position.

21. A method of providing a nasal spray pump, the method comprising the steps of:
providing a reservoir capable of containing a single dose of material to be dispensed such that the reservoir extends between a closed end and an open end;
providing a cap over the open end of the reservoir wherein the cap includes an aperture;
providing a stem through the cap aperture wherein the stein extends between an outlet end and a lower end, the stem having a conduit extending from the outlet end of the stem to a conduit inlet at or adjacent the lower end of the stein; and
disposing a conduit inlet valve about part or all of the stem wherein the conduit inlet valve is movable between a first position wherein the conduit inlet valve seals or substantially seals the conduit inlet and a second position wherein the conduit inlet valve is moved away from the first valve position to open the conduit inlet; and
configuring the stem for movement from a first stem position wherein the conduit inlet valve is disposed in or over the reservoir in the first valve position and a second stem position wherein the stem is moved toward the closed end of the reservoir such that the conduit inlet valve is moved into the second valve position.

22. A nasal spray pump valve for a nasal spray pump having a reservoir extending between an open end and a closed end and configured to contain a predetermined dose of material to be delivered intra-nasally, the reservoir being configured to receive a sealing cap over the open end of the reservoir such that the cap includes an aperture, the nasal spray pump valve comprising:
a stem extending between an outlet end and a lower end, the stem having a conduit extending from the outlet end of the stem to a conduit inlet at or adjacent the lower end of the stem; and
a conduit inlet valve disposed about part or all of the stem and movable between a first position wherein the conduit inlet valve seals or substantially seals the conduit inlet and a second position wherein the conduit inlet valve is moved from the first conduit inlet valve position to open the conduit inlet;
wherein the stem is movable from a first stem position wherein the conduit inlet valve is disposed in or over the reservoir in the first conduit inlet valve position and a second stem position wherein the stem is moved toward the closed end of the reservoir such that the conduit inlet valve is moved into the second conduit inlet valve position.
